(19) United States
(12) Patent Application Publication
(10) Pub. No.: US 2016/0004460 A1
(43) Pub. Date: Jan. 7, 2016

(54) COMPUTER SYSTEM AND CONTROL METHOD

(71) Applicant: HITACHI, LTD., Chiyoda-ku, Tokyo (JP)

(72) Inventors: KATSUYA SATO, Tokyo (JP); Mikio FUKUOKA, Tokyo (JP); Shintaro INOUE, Tokyo (JP)

(73) Assignee: Hitachi, Ltd., Chiyoda-ku, Tokyo (JP)

(21) Appl. No.: 14/768,165

(22) PCT Filed: Oct. 29, 2013
(86) PCT No.: PCT/JP2013/079251

§ 371 Date: Aug. 14, 2015

(51) Int. Cl. G06F 3/06; H04L 29/08; G06F 17/30

(52) U.S. Cl. CPC G06F 3/0617; G06F 17/30197; G06F 17/30233; G06F 3/0619; G06F 3/0646; G06F 3/067; H04L 67/1097; G06F 3/0631; G06F 3/0635

(57) ABSTRACT

The present invention provides a computer system capable of ensuring a storage capacity to a virtual volume within a pool. According to the present invention, a pool capacity of a block storage is reserved in a specific address range of the virtual volume, and a reserved capacity is allocated during writing of data to a specific address range. Further, when the reserved capacity is not allocated for a given period of time, reservation is freed.

### TECHNICAL FIELD

The present invention relates to a computer system and a method for controlling the same.

### BACKGROUND ART

In recent years, the quantity of data is increasing significantly, and the need to efficiently use storage capacities of real storage areas within a storage system is also increasing. Along therewith, the number of block storage systems including a large number of storage devices for storing data and the number of servers are increasing. Therefore, a technique is required to integrate the capacities used by the multiple servers in a block storage system, so that the multiple servers and the block storage device share the storage capacity and efficiently utilize the same.

Patent Literature 1 discloses an art of efficiently using storage capacities in a block storage system. According to the art related to the block storage system, a virtual volume is provided to the host computer, and a real storage area is allocated in response to a write request from the host computer to the virtual volume. When a virtual volume is created, the real storage area within the block storage pool is reserved according to the type of OS/application using the virtual volume. Since a large amount of data tends to be written immediately after creating the virtual volume, the creation of a virtual volume is prohibited if a given storage capacity cannot be reserved.

### CITATION LIST

### [Patent Literature]

[PTL 1] Japanese Patent Application Laid-Open Publication No. 2010-282608 (U.S. Patent Application Publication No. 2010/0312976)

### SUMMARY OF INVENTION

### [Technical Problem]

One example of a server is a NAS (Network Attached Storage) server (file server) for managing contents data. Upon using the storage capacity of a block storage system, the NAS server gathers multiple virtual volumes that the block storage system provides to the exterior as a pool for a NAS server (NAS pool). The virtual volume within the NAS pool is divided into chunks corresponding to each given address range, and the chunks are allocated to the file system. Chunks are allocated to the virtual volume in response to a write request to a file system.

However, if the real storage area allocated to the virtual volume used by the file system is insufficient, that is, if writing of data based on a write request to the file system fails, the file system is unmounted (connection is interrupted) and cannot be used. Therefore, the block storage system must ensure that a given capacity of real storage area is allocatable to the chunk (specific address range) within the virtual volume used by the file system.

According to the art of Patent Literature 1, a given storage capacity is reserved with respect to the whole virtual volume. However, if a capacity corresponding to the whole virtual volume is reserved, the storage capacity cannot be used efficiently. As described, according to the art of Patent Literature 1, the storage capacity could not be reserved with respect to a specific address range of the virtual volume. This problem occurs not only in NAS servers but in general servers.

### [Solution to Problem]

In order to solve the above problem, the computer system according to the present invention comprises a storage device including multiple storage media and a storage controller providing a virtual volume; and a server outputting a read/write request to the virtual volume provided by the storage device; wherein the storage controller divides each of the multiple storage media into multiple real storage areas, and constitutes a block storage pool having the multiple real storage areas; and when a capacity reservation request addressing a specific address range of the virtual volume is received from the server, reserves a given number of real storage areas as a capacity of the block storage pool with respect to the specific address range of the virtual volume.

Further, if a write request from the server to the virtual volume addresses the specific address range, allocates a given real storage area from the reserved real storage area, and if the write request addresses an address out of the specific address range, allocates a real storage area from a capacity not reserved in the block storage pool. Moreover, if a given condition is satisfied, the reserved capacity is freed, or switching to pool reservation is performed.

### [Advantageous Effects of Invention]

According to the computer system of the present invention, the virtual volume reserves a capacity of the block storage pool for each specific address range, so that the storage capacity can be ensured and allocation processing can be simplified, according to which the response performance can be improved. Problems, configurations and effects other than those mentioned above will become apparent from the preferred embodiments described below.

### BRIEF DESCRIPTION OF DRAWINGS

FIG. 1 is a view illustrating an outline of the present invention.

FIG. 2 is a block diagram illustrating a configuration of a computer system.

FIG. 3 is a view illustrating a configuration example of a virtual VOL mapping information table.

FIG. 4 is a view illustrating a configuration example of a pool capacity management table.

FIG. 5 is a flowchart illustrating a main processing of page reservation.

FIG. 6 is a flowchart illustrating a reserved page number acquisition processing.

FIG. 7 is a flowchart illustrating a page reservation processing.

FIG. 8 is a flowchart illustrating a tier capacity reservation processing.

FIG. 9 is a flowchart illustrating a pool capacity reservation processing.

FIG. 10 is a flowchart illustrating a reservation information setup processing to the virtual VOL.

FIG. 11 is an allocation table showing which page is allocated from a pool based on a page status of the virtual VOL.

FIG. 12 is a flowchart illustrating a page allocation processing.

FIG. 13 is a flowchart illustrating a reserved page allocation processing.

FIG. 14 is a flowchart illustrating a page allocation processing from a priority allocation tier.

FIG. 15 is a flowchart illustrating an operation accompanying excess of timer in system units.

FIG. 16 is a flowchart illustrating an operation accompanying excess of timer in VOL units.

FIG. 17 is a flowchart illustrating an operation accompanying excess of timer in page units.

FIG. 18 is a flowchart illustrating a reserved capacity freeing process.

FIG. 19 is a flowchart illustrating a cancellation processing of a set timer.

FIG. 20 is a flowchart illustrating an advance allocation processing to span.

FIG. 21 is a flowchart illustrating a VOL information acquisition processing.

FIG. 22 is a flowchart illustrating a free capacity check processing.

FIG. 23 is a flowchart illustrating an automatic freeing process of advance allocation page.

FIG. 24 is a view illustrating a problem of advance allocation to an external pool VOL.

FIG. 25 is a flowchart illustrating an advance page allocation processing to an external pool VOL.

FIG. 26 is a flowchart illustrating an external VOL information acquisition processing.

### DESCRIPTION OF EMBODIMENTS

Now, the preferred embodiments of the present invention will be described with reference to the drawings. In the following description, various information are referred to as “management tables”, for example, but the various information can also be expressed by data structures other than tables. Further, the “management table” can also be referred to as “management information” to show that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer programs can be installed to each computer from a program source. The program source can be provided via a program assignment server or a storage media, for example.

Each element, such as each controller, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical scope of the present invention. The number of each component can be one or more than one, unless defined otherwise.

### <Outline>

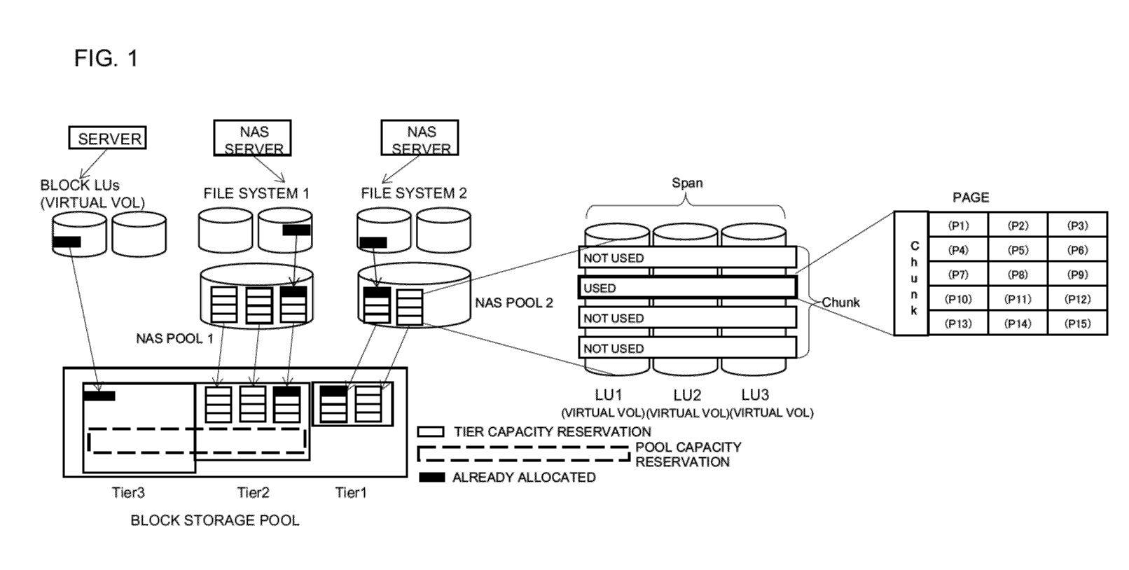

FIG. 1 illustrates an outline of the present invention. The following merits can be provided to the users by integrating the storages of respective NAS servers to a single block storage pool (an aggregate of storage drives, also simply referred to as pool).

(m1) Reduction of media costs of the block storage by optimizing the capacities of NAS servers

(m1-1) Optimization of capacity of NAS pools

A file system greater than the NAS pool capacity can be defined. A real capacity (chunk) is allocated only to a write section to the file system. A chunk is a storage unit composed of multiple storage areas managed in fixed size (such as 10 MB) units called pages.

(m1-2) Optimization of capacity of block storage pool The capacity of the block storage pool corresponding to the capacity of a pool VOL (span) capacity of the NAS pool is ensured.

(m2) Improvement of NAS throughput performance by large-scale striping

By using a virtual VOL of the block storage pool as the pool VOL of the NAS pool, it becomes possible to allocate areas of the span in a dispersed manner to multiple pool VOLs in the block storage pool. Thus, parallel access of the block storage to storage drives can be enabled, data access time can be shortened, and improvement of throughput performance of the NAS server is made possible.

In order to allocate a real capacity (chunk) to a section used by the file system, it is necessary that a capacity corresponding to a real area of the pool VOL (span) in the NAS server is ensured by the block storage pool. Therefore, in the present invention, a given tier capacity or pool capacity of a block storage system 1 is reserved (tier capacity reservation or pool capacity reservation) in a specific address range of the virtual VOL that the span uses, so as to ensure the storage capacity. Further, whether or not the write request targets an area within the reserved address range of the virtual volume is determined, and if the write request targets an area within the reserved address range, the reserved capacity of the block storage pool is allocated, but if the write request targets an area out of the reserved range, the capacity of a non-reserved area of the block storage pool is allocated. Further, if a given condition is satisfied, the reserved capacity is freed. In the following description, the units of the reserved capacity of tier capacity reservation or pool capacity reservation are set to pages, but the units are not restricted thereto.

### <Overall System>

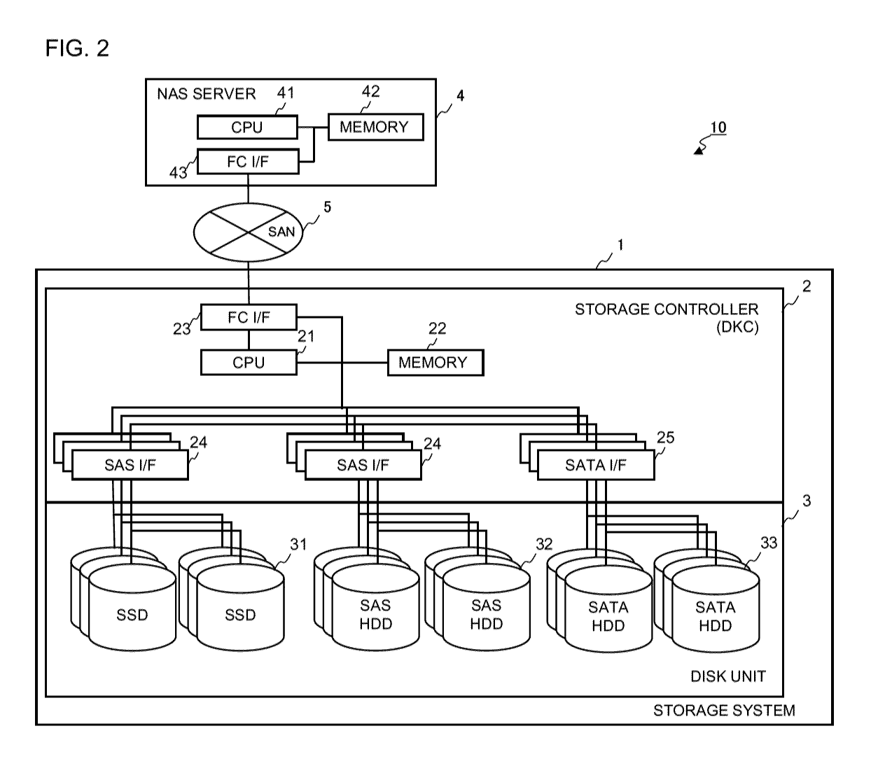

FIG. 2 is a block diagram illustrating the configuration of a computer system. The computer system 10 includes a NAS server 4 and a block storage system 1 coupled to the NAS server 4 via a SAN (Storage Area Network) 5.

The NAS server 4 has a CPU 41 for controlling the whole server, a memory 42 for storing control information such as various programs and various tables operating in the CPU 41, and a FC (Fibre Channel) I/F 43 for coupling to the SAN 5.

The block storage system 1 has a storage controller (DKC) 2 and a disk unit 3. The DKC 2 has a CPU 21 for controlling the whole system, a memory 22 for storing various programs operating in the CPU 21, various tables, system configuration information and the like, an FC_I/F 23 for coupling to the SAN 5, and a SAS_I/F 24 and a SATA_I/F 25 for coupling with multiple SSDs (Solid State Drives) 31, SAS⁻HDDs 32 and SATA-HDDs 33 of the disk unit 3.

The block storage system 1 constitutes RAID groups using multiple storage drives (SSDs 31, SAS-HDDs 32 and SATA-HDDs 33), and constitutes a block storage pool from multiple RAID groups. Further, the block storage system 1 provides a virtual VOL to the NAS server 4 as an LU (Logical Unit), and a real capacity of the block storage pool is allocated when necessary to the virtual VOL.

### <Virtual VOL Mapping Information Table>

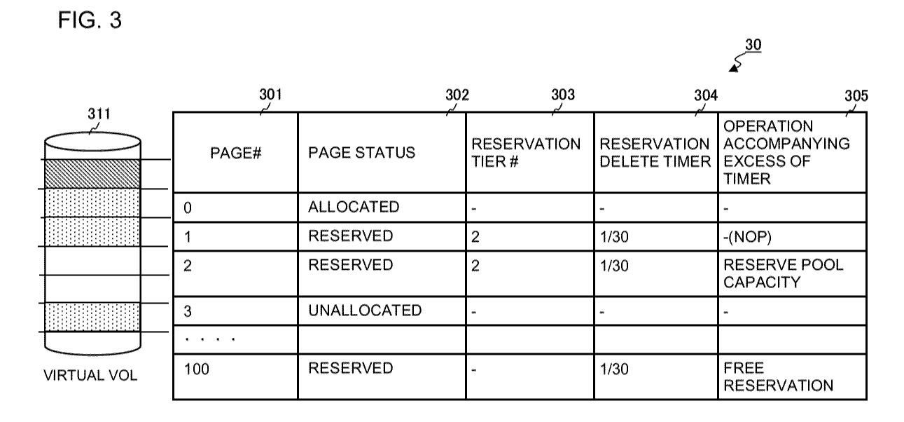

FIG. 3 is a view illustrating a configuration example of a virtual VOL mapping information table. A virtual VOL mapping information table 30 is a table for managing the allocation of real pages with respect to virtual pages of a virtual VOL 311, which includes a page # 301 for uniquely identifying a virtual page within the virtual VOL 311, an allocation page status 302 indicating the status of real pages allocated to virtual pages, a reservation tier # 303 for identifying the tier level of a reserved page, a reservation delete timer 304 for setting a given time for executing an accompanying operation to a reserved page when a given time has elapsed with the reserved page unused, and an operation accompanying excess of timer 305 for setting the type of the accompanying operation to be executed when the timer is exceeded.

An entry of the virtual VOL mapping information table 30 is set for each virtual page of the virtual VOL 311. In the page status 302, “unallocated” indicates a page that is neither reserved nor allocated, “reserved” indicates a page reserved based on an advance allocation (capacity reservation) command, and “allocated” indicates an allocated page. Further, the reservation tier # 303 can be undetermined (“-”) without setting the reservation tier level, and the pool capacity can be reserved. As a function of the operation accompanying excess of timer 305, a freeing of page reservation, changing from tier capacity reservation to pool capacity reservation, freeing of pool reservation capacity, and non-execution (NOP: No-Operation, continue reservation) are possible. In the operation accompanying excess of timer 305, it is possible to prevent continuation of unnecessary tier capacity reservation and pool reservation, and even after a given time has elapsed in the non-used state, the tier capacity and pool capacity whose reservation is to be continued can be retained in the reserved state.

### <Pool Capacity Management Table>

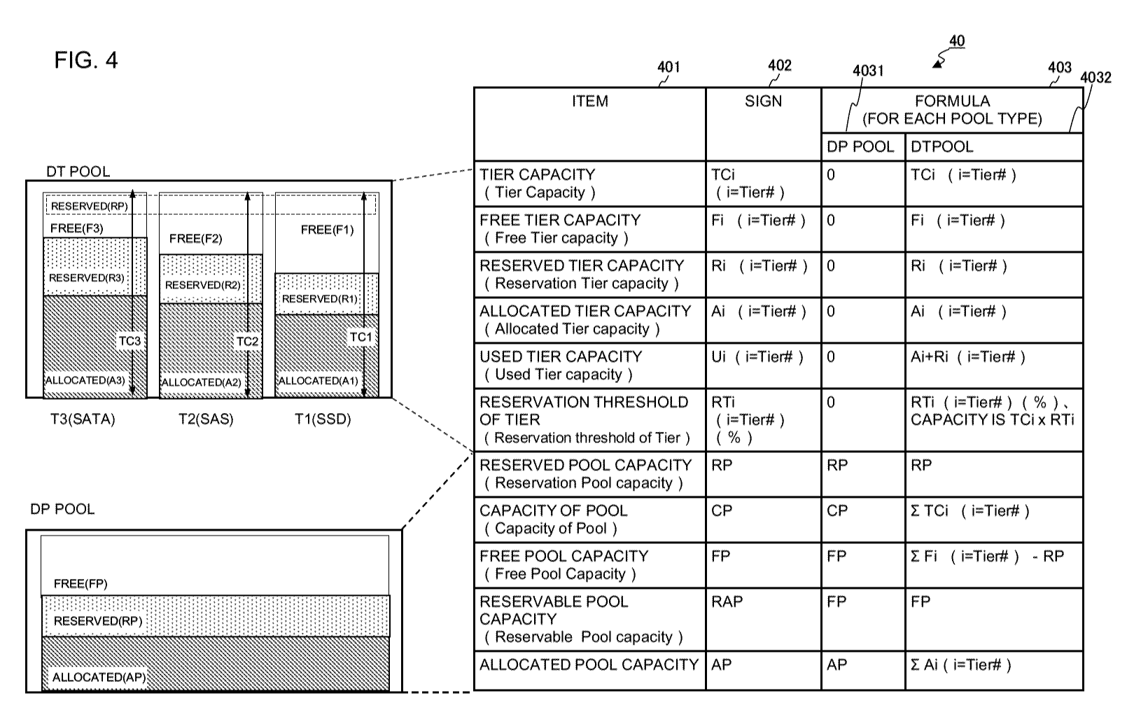

FIG. 4 is a view illustrating a configuration example of a pool capacity management table. A pool capacity management table 40 is a table for managing the respective storage capacities of each tier and the respective storage capacities based on DT (Dynamic Tiering) or DP (Dynamic Provisioning). The pool capacity management table 40 includes an item 401, a symbol 402 for uniquely identifying each item 401, and a formula (for each pool type) 403 for calculating the relevant storage capacity from the respective storage capacities.

DT is an art for dynamically reallocating the data in a virtual VOL to an appropriate storage tier (tiers of SSD/SAS-HDD, SATA-HDD) in megabyte units (such as 10 MB units) with a more detailed granularity than volume units in response to the access frequency, to thereby enable improvement of the access performance and reduction of operation costs of tier management. In FIG. 4, the tier having a smaller number i is referred to as a storage tier of an “upper tier”, wherein the upper tier has a higher access performance than a lower tier having a larger number. Further, DP is an art related to dynamically allocating real storage areas in real storage area units of a fixed size (such as the aforementioned pages) when writing data to the virtual VOL, and by writing data to the allocated storage area, which enables to cut down costs and reduces operation management.

The formula (for each pool type) 403 includes a formula for DP pool 4031 and a formula for DT pool 4032. Further, in the page status of the DP pool, “free (FP)” refers to a page that is neither reserved nor allocated (usable when allocated or reserved), “reserved (RP)” refers to a page reserved by an advance allocation command, and “capacity reservation (AP)” refers to an allocated page.

Next, the problems and methods for solving the problem will be described individually.

(p1) Problem 1

(p1-1) Increase of user response time of NAS server 4 side task (pool creation/expansion)

Before the NAS server 4 uses the virtual VOL, when page allocation is performed to ensure a real capacity (page) in a virtual VOL, the user response time is increased by the page allocation overhead on the side of the block storage (block storage system 1) by the operations (a1) through (a4) mentioned below. Therefore, it is necessary to shorten the processing time for ensuring capacity.

(a1) Issuing an instruction to create a NAS pool from the user to the NAS server 4 or an instruction to add a span (composing a single span from a pool VOL and multiple virtual VOLs);

(a2) Selecting a chunk in the NAS server 4;

(a3) Issuing an advance allocation command (Anchor command) in chunk units from the NAS server 4 to the DKC 2;

(a4) Executing allocation of a portion corresponding to a chunk capacity (corresponding to multiple pages) in DKC 2.

(p1-2) DT-VOL of non-advance allocation target cannot use upper tier The DT-VOL can designate in VOL units which tier is to be allocated with priority (priority allocation tier). Therefore, when advance allocation of a large capacity is executed with respect to a DT-VOL in which the priority allocation tier is the upper tier, a free area of the upper tier is reduced and exhausted in a short time. As a result, page allocation in a non-advance allocation target DT-VOL (volume not having capacity reserved in advance to a priority allocation tier) concentrates to a lower tier, and access performance deterioration occurs.

Tier capacity reservation or pool capacity reservation are a means for solving the above-problem (p1-1). This is performed to reserve a page (real capacity) corresponding to the capacity without having the reserved page allocated to other virtual VOLs, and not to allocate a page (real capacity) from the block storage pool to the unallocated area of the virtual VOL in synchronization with the advance allocation command.

A possible means for solving the above problem (p1-2) is a reservation capacity limitation. This method performs capacity limitation of tier capacity reservation, and allocates a free area in each tier. If the tier capacity exceeds the reservation capacity threshold by tier capacity reservation, the reservation is switched to pool capacity reservation. Another possible means for solving the problem is the operation accompanying excess of the timer. This method examines reserved pages of all virtual VOLs, switches the tier capacity reservation having exceeded the timer during the accompanying operation to freeing the tier capacity reservation or switches from tier capacity reservation to pool capacity reservation, according to which the free area of the upper tier is increased.

### <Main Processing of Page Reservation>

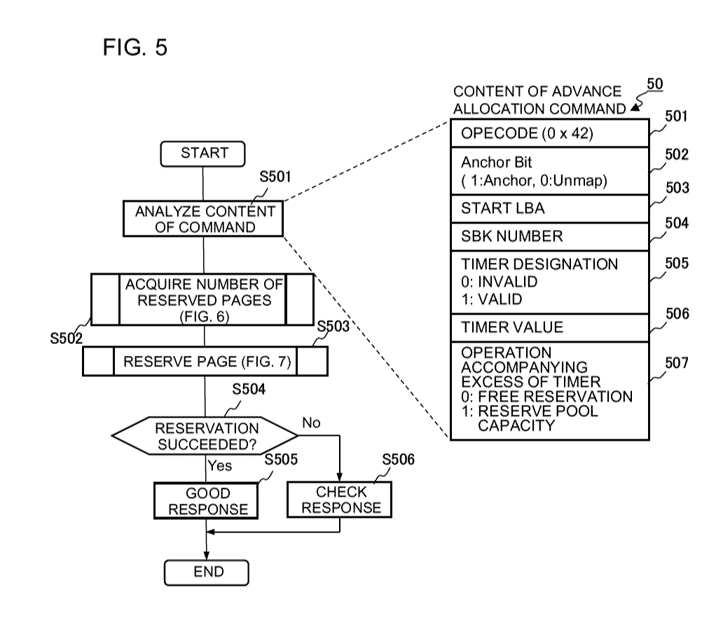

FIG. 5 is a flowchart illustrating a main processing of page reservation. The present processing is performed to reserve from the NAS server 4 an actual storage area (in page units according to the present embodiment) of the block storage system 1 in the specific address range of the virtual VOL that the file system uses, which is started when an advance allocation (reservation) command 50 from the NAS server 4 is received by the block storage system 1.

In S501, the CPU 21 of the block storage system 1 analyzes the contents of the advance allocation command 50 from the NAS server 4. The advance allocation command 50 is composed of an operation code 501 (0×42), an anchor bit (1: anchor, 0: unmapped) 502 corresponding to reservation/freeing, a start LBA (Logical Block Address) 503 indicating an initial address of the real storage area to be reserved/freed, an SBK (Sub Block) number 504 showing the data length (LBA number) to be reserved/freed, a timer designation (0: invalid, 1: valid) 505, a timer value 506 indicating the time for executing the accompanying operation, and an operation accompanying excess of timer (0: free reservation, 1: reserve pool capacity) 507.

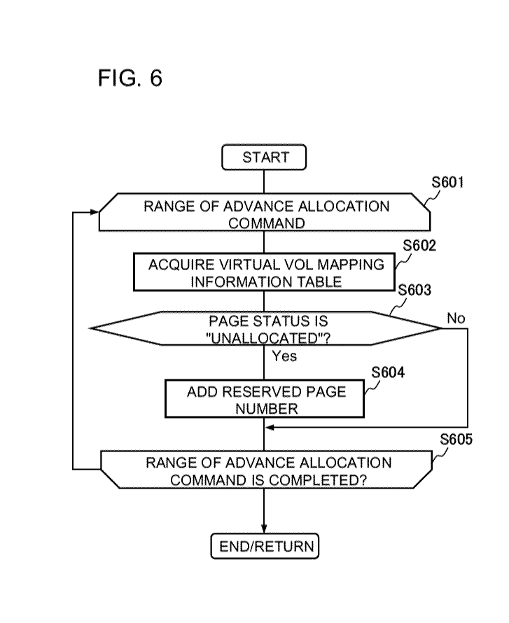

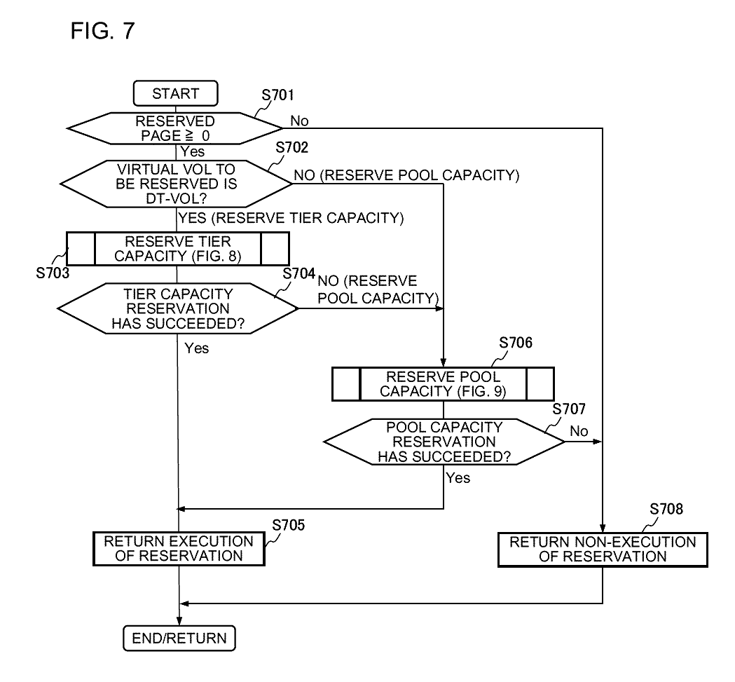

In S502, the CPU 21 executes a process for acquiring the reserved page number (FIG. 6). In S503, the CPU 21 performs page reservation of the number of pages acquired via the reserved page number acquisition process by a page reservation processing (FIG. 7). In S504, the CPU 21 determines whether the necessary page capacity (tier capacity) or pool capacity has been reserved or not. If the necessary capacity had been reserved (Yes), the CPU 21 executes S505, and if not (No), the CPU 21 executes S506.

In S505, the CPU 21 returns a good response notifying that the advance allocation command 50 had been correctly completed to the NAS server 4. In S506, the CPU 21 had not been able to reserve the necessary number of pages, so it returns a check response requesting confirmation.

### <Reserved Page Number Acquisition Processing>

FIG. 6 is a flowchart illustrating a reserved page number acquisition processing.

In S601, the CPU 21 first initializes the reserved page number, computes the range in which the advance allocation command should be executed based on a start LBA 503 and an SBK number 504 of command 50, and executes processes S602 through S604 to the pages belonging to that address range.

In S602, the CPU 21 acquires the page # 301 and the page status 302 of the virtual VOL mapping information table 30. In S603, the CPU 21 determines whether the page status 302 of the page # 301 is “unallocated” or not. If the page status 302 is unallocated (Yes), in S604, the CPU 21 adds 1 to the reserved page number, and if the page status 302 is not unallocated (No), the CPU 21 executes S605.

In S605, the CPU 21 determines whether the reserved page number acquisition processing in the address range of the advance allocation command has been competed or not. If the reserved page number acquisition processing is not completed, the CPU 21 repeats the processes of S602 and thereafter for the subsequent page, and if completed, the CPU 21 ends the reserved page number acquisition processing, and returns the process to a calling routine.

### <Page Reservation Processing>

FIG. 7 is a flowchart illustrating a page reservation processing.

In S701, the CPU 21 determines whether the reserved page number in the reserved page number acquisition processing is 0 or greater. If the number is 0 or greater (Yes), the CPU 21 executes S702, and if the reserved page number is smaller than 0 (No), the CPU 21 executes S708. In S702, the CPU 21 determines whether the virtual VOL to be reserved is a DT-VOL or not. If the virtual VOL is a DT-VOL (Yes), the CPU 21 executes 5703 to reserve the necessary tier capacity (reserved page number), and if the virtual VOL is not a DT-VOL (No), CPU 21 executes S706 to reserve the necessary pool capacity.

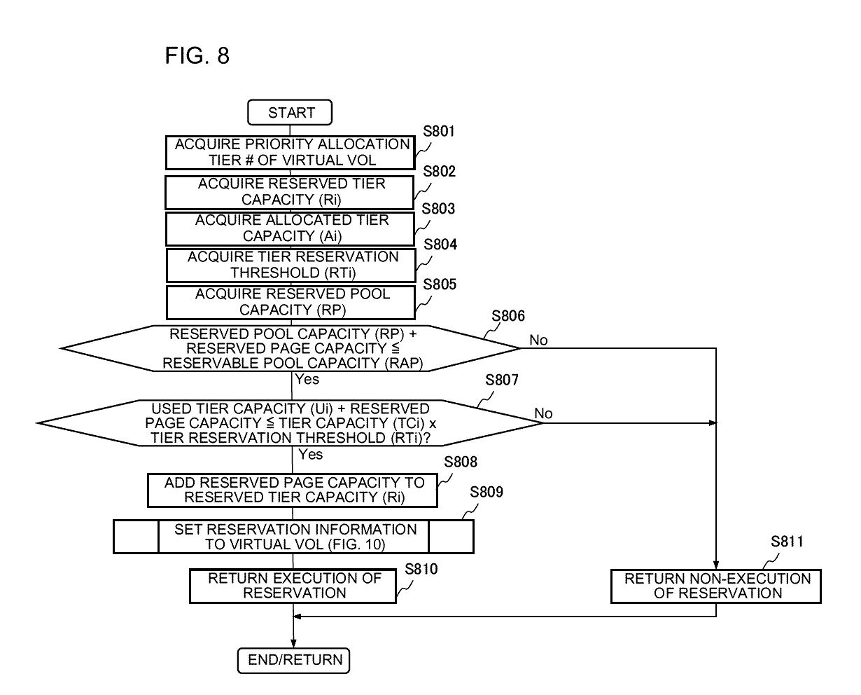

In S703, the CPU 21 executes a tier capacity reservation processing (FIG. 8). In S704, the CPU 21 determines whether the necessary tier capacity had been successfully reserved. If reservation had been successful (Yes), the CPU 21 executes S705, and if reservation has failed (No), the CPU 21 executes S706 to reserve the pool capacity. In S705, the CPU 21 returns the result of having completed the execution of tier capacity reservation to the calling routine, ends the process, and returns to S503.

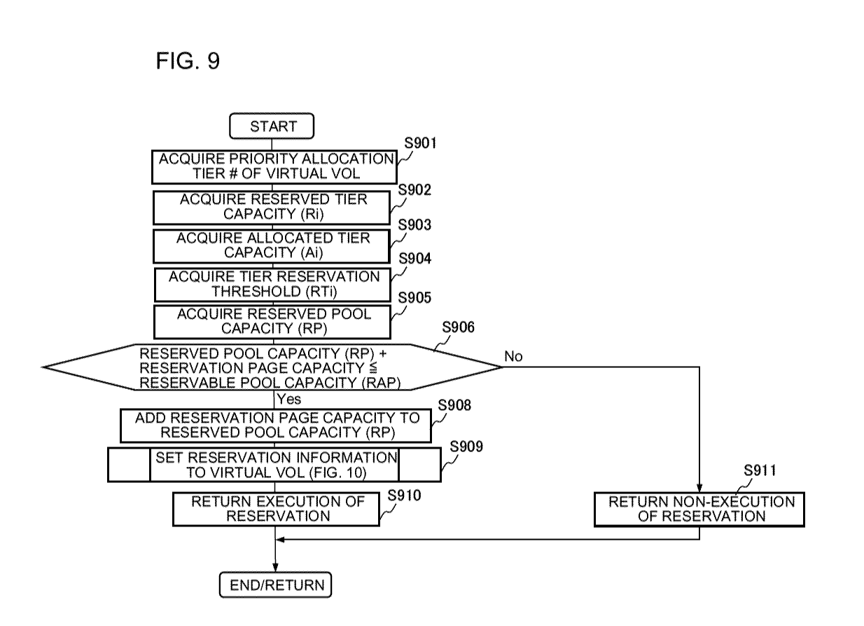

In S706, the CPU 21 executes a pool capacity reservation processing (FIG. 9). In S707, the CPU 21 determines whether reservation of the necessary pool capacity had been successful or not. If reservation had been successful (Yes), the CPU 21 executes S705, and if reservation has failed (No), the CPU 21 executes S708. In S708, the CPU 21 returns the tier capacity and the result that the reservation of pool capacity has not been executed to the calling routine, and ends the process.

### <Tier Capacity Reservation Processing>

FIG. 8 is a flowchart illustrating the tier capacity reservation processing.

In S801, the CPU 21 acquires the priority allocation tier number of the virtual VOL from a device configuration information stored in advance in the memory 22. For example, the priority allocation tier is set to tier 2 (i=2). In S802, the CPU 21 similarly acquires the reserved tier capacity (Ri=R2) from the pool capacity management table 40. In S803, the CPU 21 acquires an allocated tier capacity (Ai=A2) from the pool capacity management table 40. Then, based on formula 4032 of the DT pool, the CPU computes U2 (=R2+A2).

In S804, the CPU 21 acquires a tier reservation threshold (RTi=RT2) from the pool capacity management table 40. In S805, the CPU 21 acquires a reserved pool capacity (RP) from the pool capacity management table 40.

In S806, the CPU 21 determines whether the capacity having added the necessary reserved page capacity to the acquired reserved pool capacity (RP) is equal to or smaller than a reservable pool capacity (RAP) in the pool capacity management table 40 or not. The reservable pool capacity (RAP) is a capacity having subtracted the reserved pool capacity (RP) from a total free capacity Fi (i=1 to 3) of the respective tiers from the pool capacity management table 40. If the capacity is equal to or smaller (Yes in S806), the CPU 21 executes S807, and if the capacity is not equal to or smaller (No), the CPU 21 executes S811.

In S807, the CPU 21 determines whether the capacity having added the necessary reserved page capacity to the computed tier use capacity (U2) is equal to or smaller than the reservation capacity threshold computed by the capacity of tier 2 (TC2)×tier reservation threshold (RT2). If the computed tier use capacity (U2) is equal to or smaller than the threshold (Yes), the CPU 21 executes S808, and if the computed tier use capacity (U2) is not smaller (No), the CPU 21 executes S811.

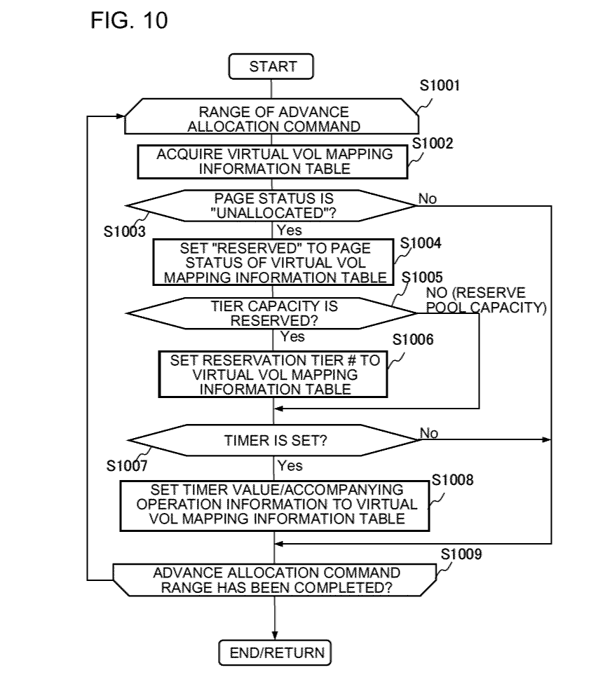

In S808, the CPU 21 adds the allocated reserved page capacity to the reserved tier capacity (R2). In S809, the CPU 21 executes a reservation information setup processing (FIG. 10) to the virtual VOL. The CPU 21 returns the result of having completed the execution of tier capacity reservation in S810, returns the result of not having executed the tier capacity reservation in S811, ends the tier capacity reservation processing, and returns the process to the calling routine.

### <Pool Capacity Reservation Processing>

FIG. 9 is a flowchart illustrating a pool capacity reservation processing. The processes from S901 to S906 are the same as S801 to S806, the process of S910 is the same as S810, and the process of S911 is the same as S811. The CPU 21 adds the necessary reservation page capacity to the reserved pool capacity (RP) acquired in S908, and executes the reservation information setup processing to the virtual VOL in S909.

### <Reservation Information Setup Processing for Virtual VOL>

FIG. 10 is a flowchart illustrating a reservation information setup processing performed to the virtual VOL.

In S1001, the CPU 21 computes the address range of the advance allocation command 50 as in process S601. In S1002, the CPU 21 acquires the page # 301 and the page status 302 in the virtual VOL mapping information table 30. In S1003, the CPU 21 determines whether the page status 302 of the relevant page is “unallocated” or not. If the relevant page is “unallocated” (Yes), the CPU 21 executes S1004, and if the relevant page is not “unallocated” (No), then the CPU 21 executes S1009.

In S1004, the CPU 21 sets the page status 302 to “reserved” in the virtual VOL mapping information table 30. The page set as reserved cannot be reserved or allocated by other virtual VOLs. In S1005, the CPU 21 determines whether it is a tier capacity reservation or not. If the reserved page set as a tier capacity reservation (Yes), the CPU 21 executes S1006, and if the reserved page set as a pool capacity reservation (No), the CPU 21 executes S1007. In S1006, the CPU 21 sets the tier number that has been reserved to the reservation tier # 303 in the virtual VOL mapping information table 30.

In S1007, the CPU 21 determines based on a timer setting 505 of the advance allocation command 50 (operation code 501: 0×42) whether timer setting is performed or not. If the timer setting is performed (the timer setting 505 is set to “1: valid”) (Yes), the CPU 21 executes S1008, and if not (No), it executes S1009. In S1008, the CPU 21 sets a timer value 506 of the advance allocation command 50 to the reservation delete timer 304 of the virtual VOL mapping information table 30, and sets up the information on the operation accompanying excess of timer 507 in the operation accompanying excess of timer 305.

In S1009, the CPU 21 determines whether the reservation information setup processing within the address range of the advance allocation command has been completed or not. If the reservation information setup processing is not completed, the CPU 21 repeats the processes of S1002 and thereafter to the subsequent address, and if completed, the CPU 21 ends the reserved page number acquisition processing, and returns the processing to the calling routine.

As described, the page allocation to the advance allocation area is performed by reserving a tier capacity or a pool capacity of the real capacity from the block storage pool corresponding to the capacity of the unallocated area of the virtual VOL, so that the relevant reserved pages will not be allocated to other virtual VOLs, without performing allocation in synchronization with the advance allocation command. Thereby, overhead of real capacity allocation of the block storage pool can be reduced, and the response performance can be improved.

### <Page Allocation Processing for Virtual VOL>

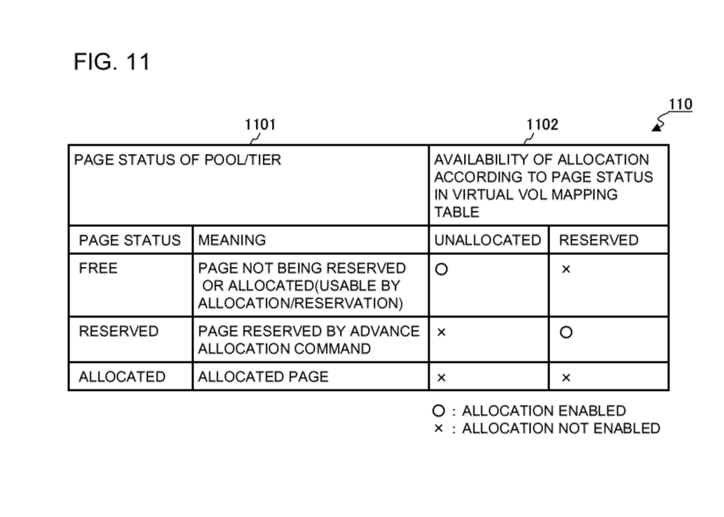

FIG. 11 is an allocation table indicating which page of the pool should be allocated based on the page status 302 with respect to the virtual VOL. An allocation table 110 includes a reference number 1101 indicating the page status of the pool/tier (free, reserved, or allocated) and the meaning of the statuses, and a page allocation possibility 1102 of the page status 302 in the virtual VOL mapping information table 30.

If the page status of the pool/tier is “free”, it can be allocated to “unallocated” in the page status 302 of the virtual VOL mapping information table 30. Similarly, if the page status of the pool/tier is “reserved”, it can be allocated to “reserved” in the page status 302.

### <Page Allocation Processing>

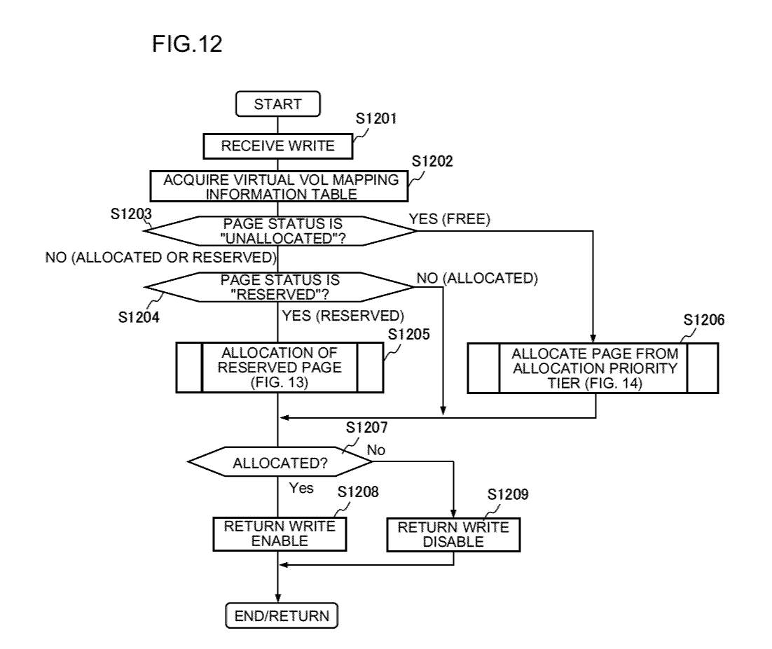

FIG. 12 is a flowchart illustrating the page allocation processing. The page allocation processing determines whether the write request relates to the area within the reserved address range of the virtual volume, wherein if the write is to be performed within the reserve address range, the reserved page of the block storage pool is allocated, and if the write is performed out of the reserved range, an unallocated page not being reserved in the block storage pool is allocated.

In S1201, the CPU 21 receives a write command from the NAS server 4. In S1202, the CPU 21 acquires the information on the write area indicated in the write command from the virtual VOL mapping information table 30. In S1203, the CPU 21 determines whether the page status 302 of the write page is “unallocated” or not. If the page status 302 is “unallocated” (Yes: “free” state), the CPU 21 executes S1206, and if the page status 302 is not “unallocated” (No: the state is either “allocated” or “reserved”), the CPU 21 executes S1204.

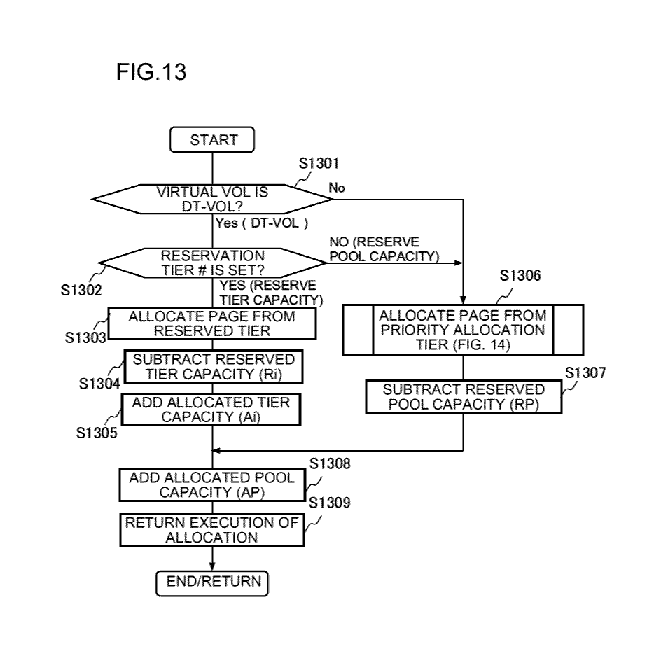

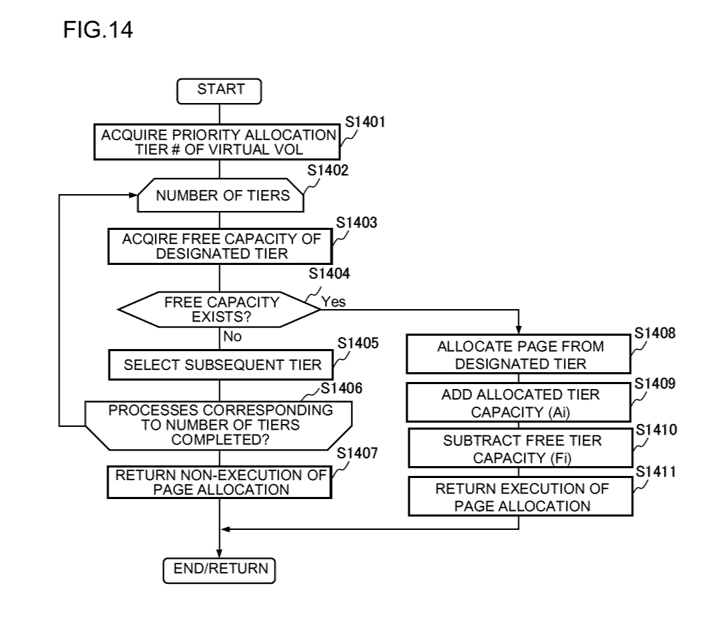

In S1204, the CPU 21 determines whether the page status 302 is “reserved” or not. If the page status 302 is not “reserved” (No: “allocated” state), the CPU 21 executes S1207, and if the page status 302 is “reserved” (Yes), the CPU 21 executes S1205. In S1205, the CPU 21 executes a reserved page allocation processing of FIG. 13. In S1206, the CPU 21 executes a page allocation processing from the priority allocation tier of FIG. 14. The processes from S1203 to S1206 correspond to the processing mentioned earlier of selecting the page (either a reserved page or an unallocated page) to be allocated from the pool based on the address range in the virtual volume.

In S1207, the CPU 21 determines whether a page has been allocated or not. If a page has been allocated (Yes), the CPU 21 executes S1208, and if a page had not been allocated (No), the CPU 21 executes S1209. In S1208, the CPU 21 responds that write is enabled to the NAS server 4, and writes the write data to the allocated page. In S1209, the CPU 21 responds that write is not enabled to the NAS server 4.

### <Reserved Page Allocation Processing>

FIG. 13 is a flowchart showing a reserved page allocation processing. The priority tier level is set to tier 1 (i=1), and the reservation tier level is set to tier 2 (i=2).

In S1301, the CPU 21 determines whether the virtual VOL is a DT-VOL or not. If the virtual VOL is a DT-VOL (Yes), the CPU 21 executes S1302, and if not (No), the CPU 21 executes S1306. In S1302, the CPU 21 checks the virtual VOL mapping information table 30, and confirms whether a tier level is set in the reservation tier # 303 or not. If a tier level is set (Yes, tier capacity reservation), the CPU 21 executes S1303, and if not (No, pool capacity reservation), the CPU 21 executes S1306.

In S1303, the CPU 21 allocates a page from the reservation tier. In S1304, the CPU 21 subtracts the capacity corresponding to the allocated page capacity from the reserved tier capacity (R2) in the pool capacity management table 40. In S1305, the CPU 21 adds the capacity corresponding to the allocated page capacity to the allocated tier capacity (A2).

In S1306, the CPU 21 executes a page allocation processing from the priority allocation tier of FIG. 14. In S1307, the CPU 21 subtracts an allocation page capacity in S1306 from the reserved pool capacity (RP). In S1308, the CPU 21 adds the allocation page capacity in S1303 or S1306 to the pool allocated capacity (AP). In S1309, the CPU 21 returns a result of completing the allocation processing, ends the reserved page allocation processing, and returns the process to the calling routine.

<Page Allocation Processing from Priority allocation Tier>

FIG. 14 is a flowchart illustrating a page allocation processing from a priority allocation tier. It is assumed that a priority tier level is set to tier 1 (i=1), the number of tiers is set to three (three tiers), and free capacity has been allocated from the priority tier 1 to realize page allocation.

In S1401, the CPU 21 acquires the priority allocation tier # of the virtual VOL. In S1402, the CPU 21 sets up the number of tiers to be processed (=3), and executes processes S1403 through S1405 to tiers 1 through 3, wherein the processing of priority tier 1 is executed first. In S1403, the CPU 21 acquires a free capacity (Fi=F1) of a priority tier 1 (designated tier) from the pool capacity management table 40.

In S1404, the CPU 21 determines whether a free capacity exists in tier 1 or not. If a free capacity exists (Yes), the CPU 21 executes S1408, and if not (No), the CPU 21 executes S1405. In S1405, the CPU 21 selects the next tier. In S1406, the CPU 21 determines whether processes corresponding to the number of tiers have been completed or not. If the processing of tiers 1 through 3 have been completed, the CPU 21 executes S1407, and if it has not been completed, the processes of S1403 through S1405 are repeated for the subsequent tier. In S1407, the CPU 21 determines that page allocation cannot be performed by allocating free capacities even by checking tiers 1 through 3, and returns the result that page allocation had not been executed.

In S1408, the CPU 21 executes page allocation from the designated tier having the free capacity successfully allocated. In S1409, the CPU 21 adds an allocated page capacity to the allocated capacity (Ai=A1) of the tier. In S1410, the CPU 21 subtracts the allocated page capacity from the free capacity (Fi=F1) of the tier. In S1411, the CPU 21 returns a result of completing the execution of page allocation, ends the page allocation processing, and returns the process to the calling routine.

In the page allocation processing of FIG. 12 to the page allocation processing from the priority allocation tier of FIG. 14, when a write request occurs to the advance allocation area (area having performed tier capacity reservation or pool capacity reservation) of the virtual VOL, a real storage area can be allocated.

### <Freeing of Reserved Page>

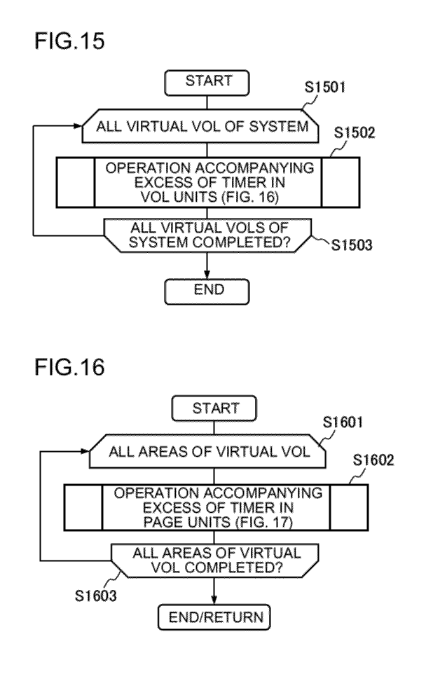

Next, from FIGS. 15 through 17, the process of freeing a reserved page that had not been allocated to the virtual VOL even after a given time has elapsed from tier capacity reservation or pool capacity reservation will be described, based on an example where the process is executed to all reserved pages of all virtual VOLs of the block storage system.

### <Operation Accompanying Excess of Timer in System Units>

FIG. 15 is a flowchart illustrating the processing of operation accompanying excess of timer in system units.

In S1501, in order to execute the process of S1502, the CPU 21 extracts all virtual VOLs created in the block storage system 1, and sets the number of VOLs. In S1502, the CPU 21 executes an operation accompanying excess of timer in VOL units (FIG. 16). In S1503, the CPU 21 determines whether the processing of S1502 has been completed for all virtual VOLs of the extracted block storage system 1, and when it is not completed, the CPU 21 executes process S1502 for the subsequent virtual VOL, and if completed, the CPU 21 ends the process.

### <Operation Accompanying Excess of Timer in VOL Units>

FIG. 16 is a flowchart illustrating the operation accompanying excess of timer in VOL units. The present processing is executed for all virtual VOLs extracted in the process of FIG. 15.

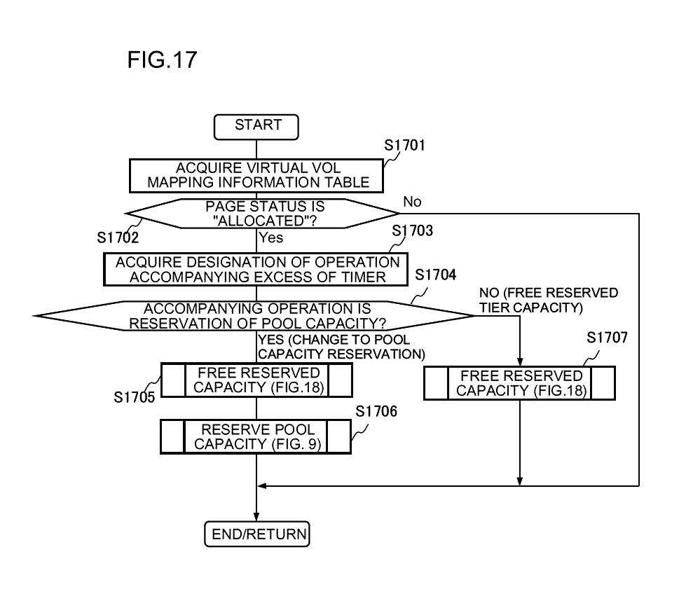

In S1601, the CPU 21 sets up the number of all pages in all areas of the virtual VOL. In S1602, the CPU 21 executes processing of operation accompanying the excess of timer in page units (FIG. 17). In S1603, the CPU 21 determines whether processing has been completed for the pages of all areas of the virtual VOL, wherein if the processing is not completed, the CPU 21 executes process S1602 to the subsequent page, and if the processing is completed, the process is ended and returned to the calling routine.

### <Operation Accompanying Excess of Timer in Page Units>

FIG. 17 is a flowchart illustrating the operation accompanying the excess of timer in page units. The present process is executed for all virtual pages extracted in the process of FIG. 16.

In S1701, the CPU 21 acquires the information on the page status 302 of the virtual VOL mapping information table 30. In S1702, the CPU 21 determines whether the page status 302 is “reserved” or not. If the page status 302 is “reserved” (Yes), the CPU 21 executes S1703, and if not (No), the process is ended and the procedure is returned to the calling routine. In S1703, the CPU 21 acquires information set in the operation accompanying excess of timer 305 in the virtual VOL mapping information table 30.

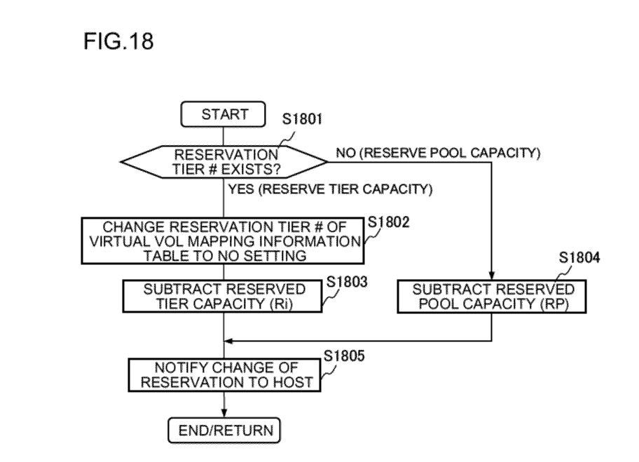

In S1704, the CPU 21 determines whether the information on the acquired operation accompanying excess of timer 305 is a “pool capacity reservation” or not. If the information is a “pool capacity reservation” (Yes), in order to change the status of the virtual page from tier capacity reservation to pool capacity reservation, the CPU 21 executes a reserved capacity freeing process (FIG. 18) of S1705 to free the tier capacity, and newly reserves a pool capacity in S1706. If the information is not a “pool capacity reservation” (No), the CPU 21 executes S1707 to free the reservation tier capacity. Then, the processing of the operation accompanying the excess of timer in page units is ended, and the procedure is returned to the calling routine. The operation accompanying excess of timer enables to free the reserved page that is not allocated to a virtual VOL after the elapse of a given time after reservation of the tier capacity or pool capacity, so that efficient use of storage capacity in a block storage can be realized.

### <Reserved Capacity Freeing Process>

FIG. 18 is a flowchart illustrating a reserved capacity freeing process.

In S1801, the CPU 21 determines whether information (tier level value i, wherein i=2) is stored in the reservation tier # 303 of the virtual VOL mapping information table 30 or not. If information is stored (Yes), the CPU 21 determines that tier capacity reservation is performed, and executes freeing of tier capacity of S1802. On the other hand, if there is no information (No), the CPU 21 determines that pool capacity reservation is performed, and executes freeing of pool capacity of S1804.

In S1802, the CPU 21 changes the information on the reservation tier # 303 in the virtual VOL mapping information table 30 to no setting “-”, and frees the page of the tier reserved to the virtual page. In S1803, the CPU 21 subtracts the freed page capacity from the reserved capacity (R2) of the tier. In S1804, the CPU 21 subtracts the freed page capacity from the reserved capacity (RP) of the pool. In S1805, the CPU 21 transmits a reservation change notice to the host (NAS server 4 etc.), ends the reserved capacity freeing process, and returns the process to the calling routine.

In the operation accompanying excess of timer in system units of FIG. 15 to the reserved capacity freeing process of FIG. 18, by performing freeing of a reserved page in the reserved area having passed the setting time, changing to the pool capacity reservation, and freeing of the reserved pool capacity to the advance allocation area (tier capacity reservation area or pool capacity reservation area) of the virtual VOL, it becomes possible to allocate the reserved capacity to other virtual VOLs and have the capacity reserved or allocated. Therefore, it becomes possible to improve the efficiency of use of the storage capacity.

### <Cancellation Processing of Setup Timer>

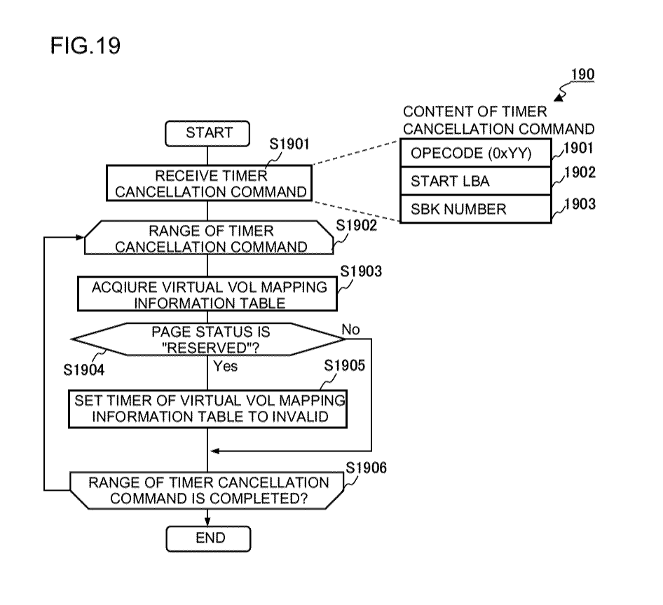

FIG. 19 is a flowchart illustrating a cancellation processing of a setup timer. The cancellation processing of the setup timer is a processing for invalidating the timer cancellation information being set in the virtual VOL mapping information table 30. In S1901, the CPU 21 receives a timer cancellation command 190. The timer cancellation command 190 includes an operation code 1901 (0×YY, the value of YY is a value that is not overlapped with other commands), a start LBA 1902, and an SBK number 1903. In S1902, the CPU 21 computes and sets up an application range of the timer cancellation command based on the start LBA 1902 and the SBK number 1903. Further, an initial page number is calculated from the start LBA 1902.

In S1903, the CPU 21 acquires the information of the page status 302 of the relevant page in the virtual VOL mapping information table 30. In S1904, the CPU 21 determines whether the page status 302 is “reserved” or not. If the page status 302 is “reserved” (Yes), the CPU 21 executes S1905, and if not (No), the CPU 21 executes S1906.

In S1905, the CPU 21 enters “-” to set the reservation delete timer 304 and the operation accompanying excess of timer 305 to invalid in the virtual VOL mapping information table 30. In S1906, the CPU 21 determines whether the processing in the application range of the timer cancellation command has been completed or not, wherein if the processing is not completed, the processes of S1903 and thereafter are repeated, and if completed, the timer cancellation processing is ended. Thereby, the timer setting of the reserved page can be cancelled, so that the reserved page having the cancellation set can be reserved successively.

(p2) Problem 2

(p2-1) The issue order of advance allocation command cannot be ensured

The chunk of the span (real storage area of the NAS pool) can extend over multiple virtual VOLs. Therefore, the NAS server 4 must issue a number of advance allocation commands corresponding to the number of extend-overs in the order (P1, P2 and P3 in the chunk illustrated in FIG. 1) of the virtual VOL corresponding to a single span. Further, if advance allocation is not realized for all the pages (P1 through P3) of the virtual VOL corresponding to the chunk, it cannot be used as chunk.

For example, when capacity has been exhausted in the advance allocation to virtual VOL (LU3) of P3, the advance allocation to the virtual VOL (LU1/LU2) of P1 and P2 becomes meaningless, and may cause the file system to be unmounted.

Now, one means for solving this problem (P2-1) is the advance allocation of the NAS server 4 to the span. If the NAS server 4 checks the free capacity of the DKC 2 side pool of the block storage system 1 and determines that sufficient free capacity exists, an advance allocation command to the span is issued. Further, if the DKC 2 returns a check response (returns NG) by capacity exhaustion or the like during issuing of the advance allocation command, rollback (freeing) is performed via an allocation freeing command to the advance-allocated page.

### <Advance Allocation Processing to Span>

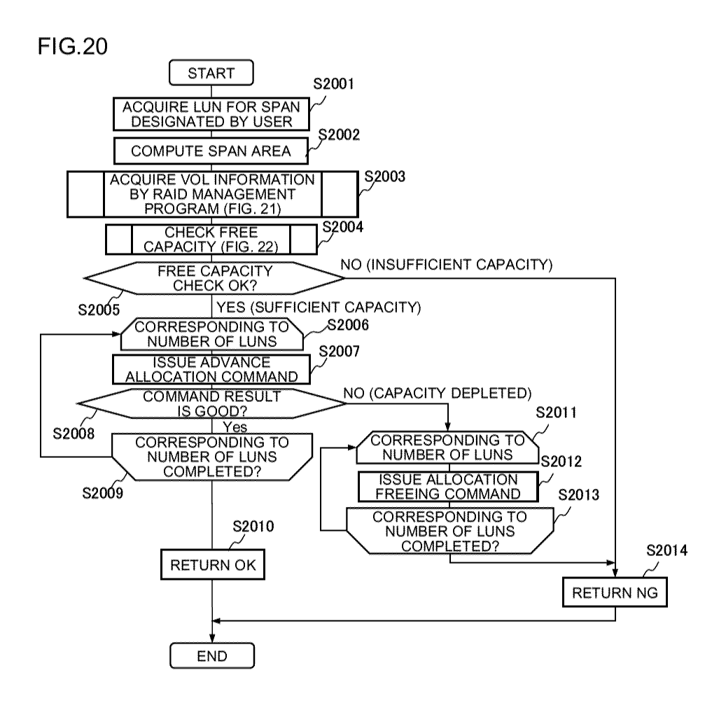

FIG. 20 is a flowchart illustrating an advance allocation processing to the span.

In S2001, the CPU 21 acquires information (number of LUNs, volume capacity and the like) on the LUN (Logical Unit Number) for the span designated by the user and received by the block storage system 1. In S2002, the CPU 21 computes the area constituting the span based on the acquired LUN information.

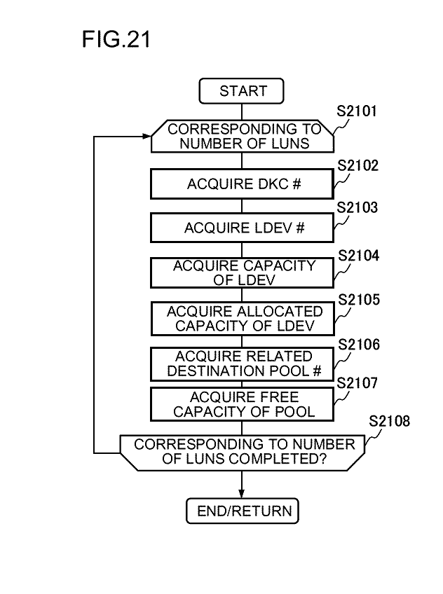

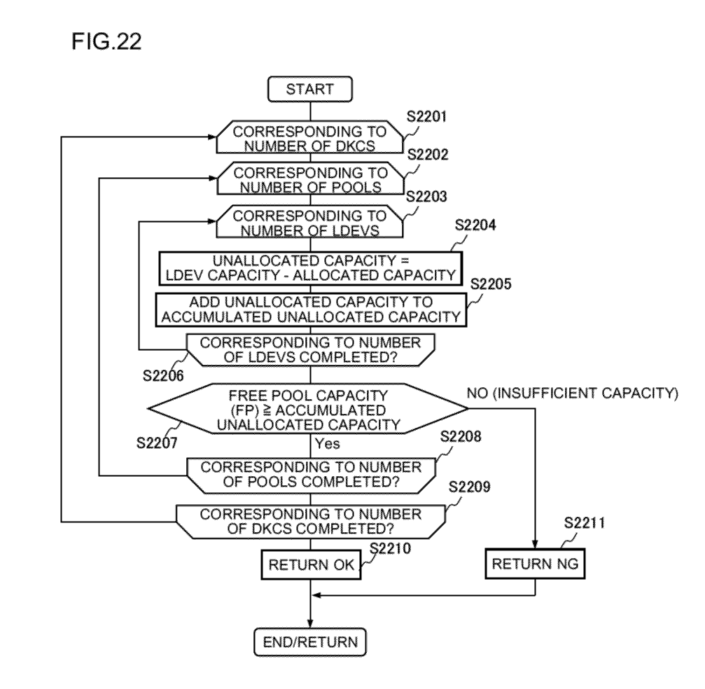

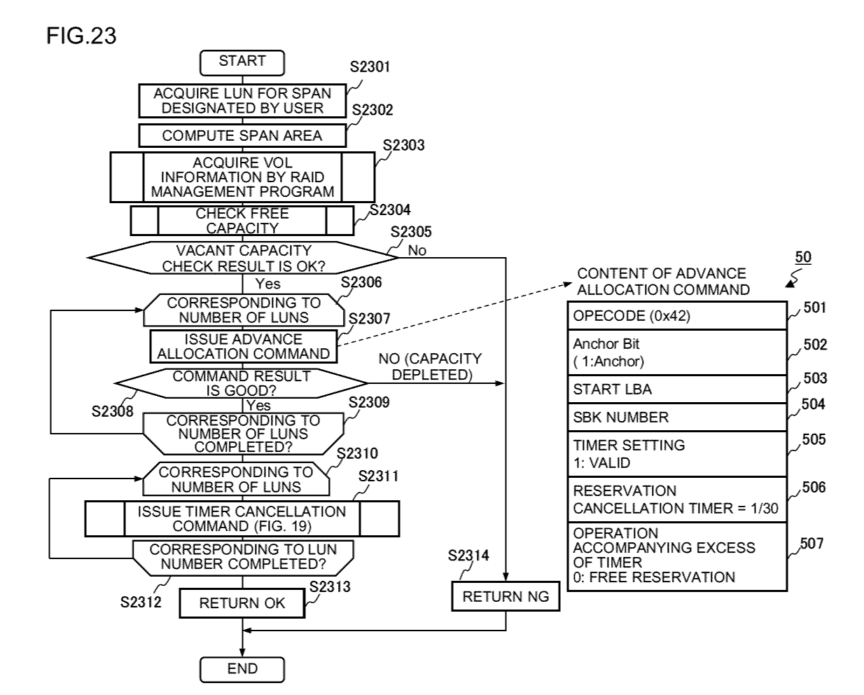

In S2003, the CPU 21 acquires the VOL information via a VOL information acquisition processing (FIG. 21) by a RAID management program (program for managing RAID groups and volumes). In S2004, the CPU 21 executes a free capacity check processing (FIG. 22) based on the acquired VOL information. In S2005, the CPU 21 determines whether the free capacity check is OK or not. If the free capacity check is OK (Yes, sufficient capacity), the CPU 21 executes S2006, and if not OK (No, insufficient capacity), the CPU 21 executes S2014.

In S2006, the CPU 21 sets the number of LUNs to be processed. In

S2007, the CPU 21 issues an advance allocation command, and executes a page reservation processing (FIG. 5). In S2008, the CPU 21 determines whether the returned command result is good or not. If the result is good (Yes), the CPU 21 performs the processes of S2007 and S2008 to the set number of LUNs (S2009). In S2010, the CPU 21 responds OK to the host of the user, and notifies that the advance allocation to the span has ended correctly.

In S2011, the CPU 21 sets the number of LUNs having issued the advance allocation command, and issues an allocation freeing command (setting an anchor bit 502 to 0: unmapped in the advance allocation command 50) to the LUN in S2012, and frees the reserved page. Then, in S2014, the CPU 21 responds NG to the host of the user, and notifies that advance allocation to the span could not be performed.

### <VOL Information Acquisition Processing>

FIG. 21 is a flowchart illustrating a VOL information acquisition processing. The CPU 21 executes the processes from S2102 to S2107 corresponding to the number of LUNs acquired in S2001, and acquires the VOL information of the LUN for the span.

The CPU 21 acquires the DKC # (DKC number) in S2102, the LDEV # (LDEV number) in S2103, the overall capacity of the LDEV in S2104, the allocated capacity of the LDEV in S2105, the pool # (pool number) related to the LDEV in S2106, and the free capacity of the pool in S2107. The above-described processes are executed for each LUN, and the VOL information for each LUN is acquired.

### <Free Capacity Check Processing>

FIG. 22 is a flowchart illustrating a free capacity check processing. The CPU 21 sets the number of DKCs acquired in the VOL information acquisition processing of FIG. 21 in S2201, the pool number in S2202 and the LDEV number in S2203, and initializes the accumulated unallocated capacity to 0.

In S2204, the CPU 21 subtracts the allocated capacity from all capacities of the LDEV, and calculates the unallocated capacity in the LDEV. In S2205, the CPU 21 adds an unallocated capacity in the accumulated unallocated capacity. The processes of S2204 and S2205 are repeated corresponding to the number of LDEVs, based on which the accumulated unallocated capacity is calculated.

In S2207, the CPU 21 determines whether the free pool capacity (FP) acquired in S2107 is equal to or greater than the accumulated unallocated capacity or not. If the free pool capacity (FP) is not equal to or greater (No), the CPU 21 determines that capacity is insufficient, and returns NG to the main routine (FIG. 20) (S2211). If the free pool capacity (FP) is equal to or greater (Yes in S2207), the CPU 21 determines whether processes corresponding the number of pools have been completed or not in S2208, and if the process is not completed, the accumulated unallocated capacity is initialized to 0 and the processes of S2203 to S2207 are re-executed. In S2209, the CPU 21 determines whether processes corresponding to the number DKCs have been completed or not, and if not completed, the accumulated unallocated capacity is initialized to 0 and the processes of S2203 to S2207 are re-executed. When the free capacity has been allocated in all DKCs and pools, the CPU 21 returns in S2210 that the free capacity check is OK.

As described, issuing of unnecessary advance allocation commands can be reduced by checking the free capacity of the pool before issuing the advance allocation command and confirming whether capacity necessary for reservation can be allocated or not.

(p2-2) In case the NAS server loses a command issued area information

Regarding the issuing order of commands, for example, in a case where the NAS server 4 is restarted by power failure or the like, there is a possibility that the number of commands issued by the NAS server 4 becomes unclear. Then, the reserved area subjected to advance allocation will remain falsely, so that it becomes necessary to free the reserved area.

A possible method for solving the above problem (p2-2) is the automatic freeing of an advance allocation page by the block storage system 1. When the NAS server 4 issues an advance allocation command to the span, the timer setting 505 of the advance allocation command 50 is set to “1: valid”, a reservation delete timer 506 is set to a given value (such as to 1/30 (January 30) which is the date), and a bit of the operation accompanying excess of timer 507 is set to “0: free reservation”. Then, when the timer cancellation command 190 is not issued from the NAS server 4 to the block storage system 1 until the set date in the timer value 506, the DKC 2 will automatically free the capacity reserved by the tier capacity reservation and the pool capacity reservation. Instead of the date, it is possible to set a given time, and when the timer cancellation command 190 is not executed even after a given time has elapsed after setting, the capacity reserved by the tier capacity reservation or the pool capacity reservation can be freed.

### <Automatic Freeing Process of Advance Allocation Page>

FIG. 23 is a flowchart illustrating an automatic freeing process of an advance allocation page. The processes of S2301 to S2309 are equivalent to the processes of S2001 to S2009, and the difference is that the advance allocation command 50 of S2307 is set to automatically free the reserved page when the timer has been exceeded.

The CPU 21 monitors whether the timer cancellation command 190 to the block storage system 1 had been issued from when the issuing of the advance allocation command 50 of S2309 had been completed. If the timer cancellation command 190 is not issued, the CPU 21 of DKC 2 issues in S2311 the timer cancellation command 190 to all the areas to which the advance allocation command 50 had been issued, and frees the reserved pages.

As described, even when the timer cancellation command 190 is not issued by the NAS server within a given time, the DKC 2 of the block storage system 1 can free the reserved page automatically so that the falsely remaining reserved capacity can be freed, and therefore, efficient use of storage area is enabled.

(p3) Problem 3

(p3-1) Lack of capacity in external VOL

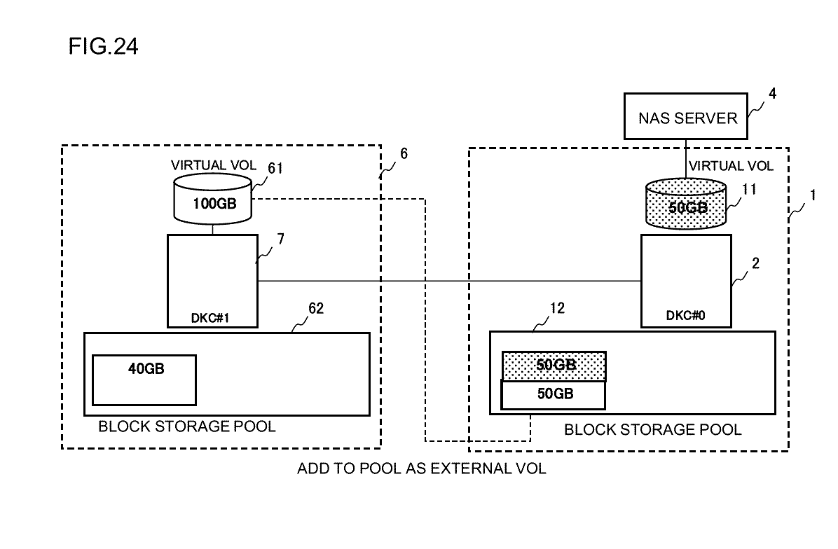

In a configuration where an external VOL is included as pool in the block storage pool, when the external VOL is a virtual VOL of DP, capacity reservation by an advance allocation command is enabled. However, it is possible that the pool of the external VOL may be full and data cannot be written thereto when actually executing a write I/O. This problem will be described with reference to FIG. 24. FIG. 24 is a view illustrating the problem of advance allocated to an external pool VOL.

It is assumed that a virtual VOL 61 of 100 GB is created in an external block storage system 6 coupled to the block storage system 1, and a block storage pool 62 of an external block storage system of 40 GB is allocated to the virtual VOL 61. If the virtual VOL 61 is allocated to the block storage pool 12 of the block storage system 1, advance allocation of 50 GB (corresponding to the capacity of the virtual VOL 11), for example, is enabled. However, the actual capacity where write is enabled from the NAS server 4 via the DKC # 0 2 to DKC #1 7 is 40 GB, a write exceeding 40 GB is not possible since the block storage pool of the external block storage system 6 is full. Therefore, the capacity reserved by the advance allocation command must be written without fail when allocated.

Therefore, when adding the external VOL to the pool of the block storage system 1, only the capacity being allocated via the advance allocation command is registered as the pool VOL capacity. Thereby, the above problem (p3-1) can be solved.

### <Advance Page Allocation Processing to External Pool VOL>

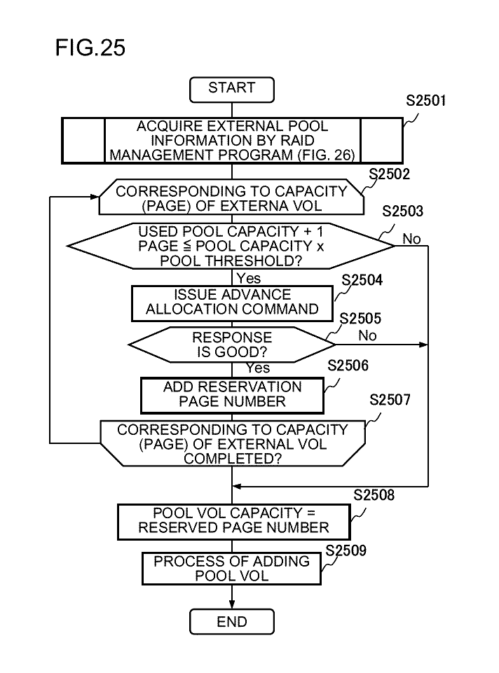

FIG. 25 is a flowchart illustrating an advance page allocation processing to the external pool VOL.

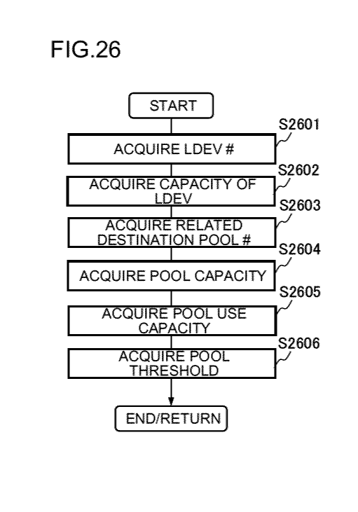

In S2501, the CPU 21 acquires the pool information of the external VOL in the RAID management program (FIG. 26). Then, the reserved page number is initialized to 0. The CPU 21 executes the processes of S2502 to S2507 corresponding to the number of pages of the external VOL capacity acquired in S2501. In S2503, the CPU 21 determines whether the capacity having added the capacity corresponding to a single page to the acquired used pool capacity is equal to or smaller than the capacity having multiplied the pool capacity acquired in S2501 by the similarly acquired pool threshold. If capacity is exceeded (No), the CPU 21 executes S2508, and if the capacity is equal to or smaller than the capacity (Yes), the CPU 21 executes S2504.

The CPU 21 issues an advance allocation command in S2504, and determines in S2505 whether the response is good or not. If the response is good (Yes), the CPU 21 adds a single page to the reserved page number in S2506, and adds a capacity corresponding to a single page to the used pool capacity of the external VOL. In S2507, the CPU 21 determines whether processing of the number of pages corresponding to the capacity of the external VOL has been completed, and if not completed, the processes of S2503 and thereafter are repeated. Then, the CPU 21 sets the capacity corresponding to the reserved page number having been allocated in S2508 as the pool VOL capacity, additionally registers the external VOL as pool VOL in S2509, and ends the process.

### <External VOL Information Acquisition Processing>

FIG. 26 is a flowchart illustrating an external VOL information acquisition processing. The processes of S2601 and S2602 are the same as the processes of S2103 and S2104, and the process of S2603 is the same as the process of S2106. The CPU 21 acquires the pool capacity in S2604, the used pool capacity in S2605, and the pool threshold in S2606.

As described, upon adding an external VOL to the pool of the block storage system 1, only the capacity having been allocated via the advance allocation command is registered as the pool VOL capacity, so that the problem of not being to execute an actual write process to the advance allocation area can be solved.

The present invention is not restricted to the above-illustrated preferred embodiments, and can include various modifications. The above-illustrated embodiments are described in detail to help understand the present invention, and the present invention is not restricted to a structure including all the components illustrated above. Further, a portion of the configuration of an embodiment can be replaced with the configuration of another embodiment, or the configuration of a certain embodiment can be added to the configuration of another embodiment. Moreover, a portion of the configuration of each embodiment can be added to, deleted from or replaced with other configurations.

A portion or whole of the above-illustrated configurations, functions, processing units, processing means and so on can be realized via hardware configuration such as by designing an integrated circuit. Further, the configurations and functions illustrated above can be realized via software by the processor interpreting and executing programs realizing the respective functions. The information such as the programs, tables and files for realizing the respective functions can be stored in storage devices such as memories, hard disks or SSDs (Solid State Drives), or in memory media such as IC cards, SD cards or DVDs. Only the control lines and information lines considered necessary for description are illustrated in the drawings, and not necessarily all the control lines and information lines required for production are illustrated. In actual application, it can be considered that almost all the components are mutually coupled.

### REFERENCE SIGNS LIST

1: Block storage system, 2: Storage controller (DKC), 3: Disk unit, 4: NAS server, 10: Computer system, 21: CPU, 30: Virtual VOL mapping information table, 40: Pool capacity management table, 50: Advance allocation command, 190: Timer cancellation command, 505: Timer designation, 506: Timer value, 507: Operation accompanying excess of timer.

1. A computer system comprising:
a storage device including multiple storage media, and a storage controller providing a virtual volume; and
a server outputting a read/write request to the virtual volume provided by the storage device;
wherein the storage controller
divides each of the multiple storage media into multiple real storage areas, and constitutes a block storage pool having the multiple real storage areas;
when a capacity reservation request addressing a specific address range of the virtual volume is received from the server, reserves a given number of real storage areas as a capacity of the block storage pool with respect to the specific address range of the virtual volume;
if a write request from the server to the virtual volume addresses the specific address range, allocates a given real storage area from the reserved real storage area, and if the write request addresses an address out of the specific address range, allocates a real storage area from a capacity not reserved in the block storage pool.

2. The computer system according to claim 1, wherein
the block storage pool includes multiple storage tiers, each tier having a reservation capacity threshold set thereto; and
when a reservation capacity of a tier for reserving the given number of real storage areas exceeds the reservation capacity threshold, then the capacity of a tier other than said tier will be reserved.

3. The computer system according to claim 1, wherein
if a set amount of time has elapsed from a point of time when the given number of real storage areas are reserved, or if a given time has arrived but the given number of real storage areas are not allocated to the specific address range of the virtual volume, then the reserved capacity is freed.

4. The computer system according to claim 2, wherein
if a set amount of time has elapsed from a point of time when the given number of real storage areas are reserved, or if a given time has arrived but the given number of real storage areas are not allocated to the specific address range of the virtual volume, then switching is performed from tier capacity reservation to pool capacity reservation.

5. The computer system according to claim 1, wherein the storage device has an external storage device including multiple storage media coupled thereto;
the external storage device constitutes an external block storage pool from the storage media, and an external virtual volume to which the external block storage pool is allocated is provided as an external volume to the block storage pool; and
a reservation command is issued to the external volume to acquire a reservable capacity, and an external volume having the reservable capacity is registered to the block storage pool.

6. The computer system according to claim 1, wherein
the server is a NAS server controlling a file system, and the NAS server manages multiple virtual volumes provided from the storage device collectively as a NAS pool, and provides the same to the file system.

7. The computer system according to claim 6, wherein
when the given number of real storage areas is composed by extending over multiple virtual volumes, the NAS server issues a reservation command for reserving a capacity for each virtual volume, and performs capacity reservation in units of the given number of real storage areas.

8. The computer system according to claim 7, wherein
if capacity reservation via a reservation command to any one of the multiple virtual volumes cannot be performed, the reserved capacity in the given number of storage areas is freed.

9. The computer system according to claim 7, wherein
if all the reservation commands to the multiple virtual volumes are not completed, then the reserved capacity in the given number of real storage areas is freed.

10. A method for controlling a computer system comprising:
a storage device including multiple storage media, and a storage controller providing a virtual volume; and
a server outputting a read/write request to the virtual volume provided by the storage device;
wherein the storage controller
divides each of the multiple storage media into multiple real storage areas, and constitutes a block storage pool having the multiple real storage areas;
when a capacity reservation request addressing a specific address range of the virtual volume is received from the server, reserves a given number of real storage areas as a capacity of the block storage pool with respect to the specific address range of the virtual volume;
if a write request from the server to the virtual volume addresses the specific address range, allocates a given real storage area from the reserved real storage area, and if the write request addresses an address out of the specific address range, allocates a real storage area from a capacity not reserved in the block storage pool.

11. The method for controlling a computer system according to claim 10, wherein
the block storage pool includes multiple storage tiers, each tier having a reservation capacity threshold set thereto; and
when a reservation capacity of a tier for reserving the given number of real storage areas exceeds the reservation capacity threshold, then the capacity of a tier other than said tier will be reserved.

12. The method for controlling a computer system according to claim 10, wherein
if a set amount of time has elapsed from a point of time when the given number of real storage areas are reserved, or if a given time has arrived but the given number of real storage areas are not allocated to the specific address range of the virtual volume, then the reserved capacity is freed.

13. The method for controlling a computer system according to claim 11, wherein
if a set amount of time has elapsed from a point of time when the given number of real storage areas are reserved, or if a given time has arrived but the given number of real storage areas are not allocated to the specific address range of the virtual volume, then switching is performed from tier capacity reservation to pool capacity reservation.

14. The method for controlling a computer system according to claim 10, wherein the storage device has an external storage device including multiple storage media coupled thereto;
the external storage device constitutes an external block storage pool from the storage media, and an external virtual volume to which the external block storage pool is allocated is provided as an external volume to the block storage pool; and
an advance allocation command is issued to the external volume to acquire a reservable capacity, and an external volume having the reservable capacity is registered to the block storage pool.

15. The method for controlling a computer system according to claim 10, wherein
the server is a NAS server controlling a file system, and the NAS server manages multiple virtual volumes provided from the storage device collectively as a NAS pool, and provides the same to the file system.

16. The method for controlling a computer system according to claim 15, wherein
when the given number of real storage areas is composed by extending over multiple virtual volumes, the NAS server issues a reservation command for reserving a capacity for each virtual volume, and performs capacity reservation in units of the given number of real storage areas.

17. The method for controlling a computer system according to claim 16, wherein
if capacity reservation via a reservation command to any one of the multiple virtual volumes cannot be performed, the reserved capacity in the given number of storage areas is freed.

18. The method for controlling a computer system according to claim 16, wherein
if all the reservation commands to the multiple virtual volumes are not completed, then the reserved capacity in the given number of real storage areas is freed.
